(19) United States
(12) Patent Application Publication
(10) Pub. No.: US 2023/0287968 A1
(43) Pub. Date: Sep. 14, 2023

(54) CLUTCH WITH TORQUE CONVERTER CLEARANCE

(71) Applicant: Valeo Kapec Co., Ltd., Daegu (KR)

(72) Inventor: Horacio LOREDO MORALES, San Luis Potosi (MX)

(73) Assignee: Valeo Kapec Co., Ltd., Daegu (KR)

(21) Appl. No.: 18/181,334

(22) Filed: Mar. 9, 2023

(30) Foreign Application Priority Data
Mar. 11, 2022 (MX) MX/A/2022/003046

(51) Int. Cl. F16H 45/02

(52) U.S. Cl. CPC F16H 45/02; F16H 2045/0221; F16H 2045/0284; F16H 2045/0278; F16H 2045/021

(57) ABSTRACT

The present invention discloses a clutch with torque converter clearance that prevents internal interference with the components of the torsional vibration filtering device, and also allows an easy and quick evaluation of the clutch clearance around 360° of the piston when the clutch is engaged. To achieve the above, a normally coupled clutch with torque converter clearance comprising a piston cap; at least one friction disc; and a piston is implemented; the piston in turn comprises a pressure plate and a cover core, where the cover core comprises a mechanical stop or retainer as main element.

### FIELD OF THE INVENTION

The present invention relates to a torque converter clutch, and more particularly relates to a torque converter clutch with clearance when the clutch is engaged.

### BACKGROUND OF THE INVENTION

A torque converter is a fluid coupling that transfers the power generated by a power source to a rotating load. In cars that use automatic transmissions, the torque converter allows the power generated by an engine to be transferred to a transmission.

The torque converter can comprise a pump housing, a cover, an impeller, a turbine, a stator, a clutch, a torsional vibration filtering device and a piston, among others.

The torque converter can reach only 80% to 90% of the power generated by the engine by an arrangement between the impeller, stator, and turbine, because of this, it is necessary to use a clutch to engage the cover directly with the transmission, wherein the cover receives the power from the engine. The clutch can be engaged or disengaged from the cover depending on the power supplied by the engine.

There are different clutches that can be used in the torque converter, such as the one described in U.S. Pat. No. 7,287,630, which describes a torque converter with a lock-up clutch that includes a fluid passage, a supplied operating oil flows in the fluid passage from a converter chamber that is surrounded by the pump impeller and the turbine impeller to a locking chamber where the engagement and disengagement of the lock-up clutch occurs. The lock-up clutch has a front cover connector which is fixed to a front cover by welding; a portion of the edge of an inlet shaft is secured to the front cover connector such that the inlet shaft is rotating with respect to the front cover connector; an outer peripheral face of the front cover connector serves as an inner peripheral face of the cylinder in which a piston moves in an axial direction of the input shaft. However, the front cover connector has a C shape, which prevents measuring the clearance between the piston and the front cover connector without completely removing them from the torque converter.

In addition, patent U.S. Pat. No. 8,327,987 describes a torque converter that includes a housing, a lock-up clutch, the lock-up clutch has a split piston that has an inner radial portion and an outer radial portion, and a drive plate that connects the housing and the outer portion. However, the inner radial portion of the split piston has a C shape which prevents measuring the clearance between the inner radial portion and the outer radial portion of the piston without having to completely remove them from the torque converter.

As a result of the above, it has been sought to eliminate the disadvantages that present the clutches of torque converter used today, developing a clutch with torque converter clearance which, in addition to preventing internal interference with the components of the torsional vibration filtering device, allows easy and quick assessment of clutch clearance around 360° of the piston when the clutch is engaged.

### OBJECT OF THE INVENTION

Considering the defects of the prior art, it is an object of the present invention to provide a clutch with torque converter clearance that prevents internal interference with the components of the torsional vibration filtering device.

It is another object of the present invention to provide a clutch with torque converter clearance that allows an easy and quick evaluation of the clutch clearance around 360° of the piston when the clutch is engaged.

These and other objects are achieved by a clutch with torque converter clearance according to the present invention.

### BRIEF DESCRIPTION OF THE INVENTION

To do this, a clutch with torque converter clearance has been invented comprising: a cover that is configured to receive a rotational motion from an engine, the cover is assembled with a pump housing; the pump housing being configured to receive the rotational movement of the cover, the pump housing is connected to an impeller; the impeller transferring the rotational motion to a turbine; the turbine transferring the rotational motion to a torsional vibration filtering device; the torsional vibration filtering device receiving rotational motion from the turbine and being configured to transfer rotational motion to a transmission; a clutch that being configured to allow a coupling between the cover and the torsional vibration filtering device, the clutch comprising a piston cap, at least one friction disc, and a piston; the piston, in turn, comprising a pressure plate and a cover core, the pressure plate being configured to apply pressure on each friction disc to connect the cover with the torsional vibration filtering device, the cover core is connected to the cover and comprising in turn a mechanical stop being configured to limit an axial movement of the pressure plate and being configured to have a clearance with the pressure plate.

### BRIEF DESCRIPTION OF THE DRAWINGS

The novel aspects that are considered characteristic of the present invention, will be particularly established in the appended claims. However, some embodiments, features and some objects and advantages of it, will be better understood in the detailed description, when read with reference to the accompanying drawings, in which:

FIG. 1 illustrates a cross-sectional view along a torque converter shaft according to a first embodiment of the present invention.

FIG. 2 illustrates a cross-sectional view along a shaft of the clutch with torque converter clearance, according to a first embodiment of the present invention.

### DETAILED DESCRIPTION OF THE INVENTION

The present invention relates to a clutch with torque converter clearance that prevents internal interference with the components of the torsional vibration filtering device, and also allows an easy and quick evaluation of the clutch clearance around 360° of the piston. To achieve the above, a clutch with torque converter clearance comprising a piston cap; at least one friction disc; and a piston is implemented; the piston in turn comprises a pressure plate and a cover core, where the cover core comprises a mechanical stop.

Thus, in one aspect of the invention, a clutch with torque converter clearance is described, comprising: a cover that is configured to receive a rotational motion from an engine, the cover is assembled with a pump housing; the pump housing being configured to receive the rotational movement of the cover, the pump housing is connected to an impeller; the impeller transferring the rotational motion to a turbine; the turbine transferring the rotational motion to a torsional vibration filtering device; the torsional vibration filtering device receiving rotational motion from the turbine and being configured to transfer rotational motion to a transmission; a clutch that being configured to allow a coupling between the cover and the torsional vibration filtering device, the clutch comprising a piston cap, at least one friction disc, and a piston; the piston, in turn, comprising a pressure plate and a cover core, the pressure plate being configured to apply pressure on each friction disc to connect the cover with the torsional vibration filtering device, the cover core is connected to the cover and comprising in turn a mechanical stop being configured to limit an axial movement of the pressure plate and being configured to have a clearance with the pressure plate.

In a preferred embodiment of the present invention, the cover core has an “L” shape in the section where the mechanical stop is located, this allows a quick assessment of the clearance between the pressure plate and the cover core around 360° of the components.

In another preferred embodiment of the present invention, the impeller transfers the rotational motion to the turbine by means of a working fluid. Preferably the working fluid is oil, being able to use another fluid that allows an optimal operation of the torque converter. Additionally, between the impeller and the turbine there is a stator.

Additionally, in one embodiment of the present invention, the torsional vibration filtering device comprises: a drive plate that is connected to the turbine, the drive plate being configured to receive the rotational movement of the turbine and/or the clutch via the piston cap; at least one spring, wherein each spring has a first end that is connected to the drive plate and a second end that is connected to a driven plate; and the driven plate receiving the rotational movement of the drive plate through each spring, the driven plate being connected to the transmission.

In one embodiment of the present invention, at least one clutch friction disc is coupled to the pressure plate, and the piston cap is coupled to the torsional vibration filtering device; at least one friction disc contacts the piston cap when the pressure plate is axially moved because pressure is applied to it. At least one friction disc and piston cap can be assembled alternately in a multi-disc structure or in a simple structure with only one friction disc.

In an additional embodiment of the present invention at least one clutch friction disc is coupled to the cover and in a preferred embodiment at least one clutch friction disc is coupled to the pressure plate and at least one second disc friction is coupled to the cover.

In another embodiment of the present invention, the pressure plate can move axially by increasing or decreasing a pressure in a first chamber of working fluid. Additionally, the piston comprises a mechanical seal that is located between the pressure plate and the cover core and is configured for preventing the passage of working fluid and pressure losses.

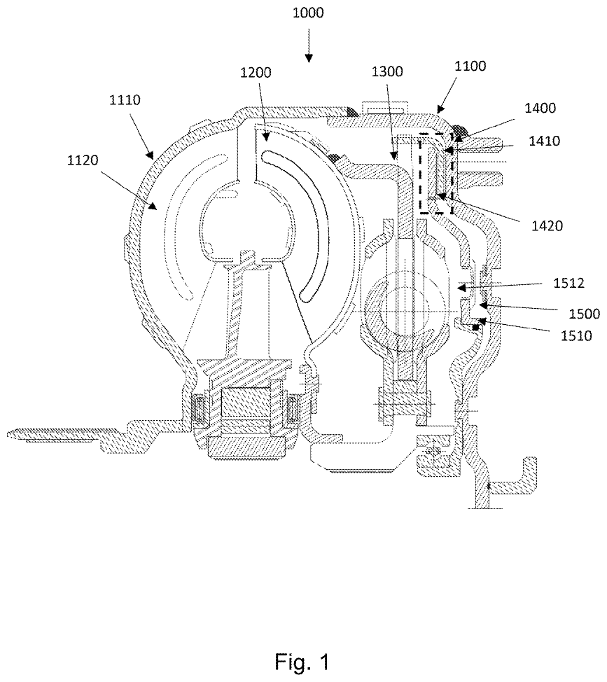

Referring now to FIG. 1, which illustrates a torque converter 1000 comprising: a cover 1100 that is configured to receive a rotational motion from an engine (not shown), the cover 1100 is assembled with a pump housing 1110; the pump housing 1110 being configured to receive the rotational movement of the cover 1100, the pump housing 1110 is connected to an impeller 1120; the impeller 1120 transferring the rotational motion to a turbine 1200; the turbine 1200 transferring the rotational motion to a torsional vibration filtering device 1300; the torsional vibration filtering device 1300 receiving rotational motion from the turbine 1200 and being configured to transfer rotational motion to a transmission (not shown); a clutch 1400 that being configured to allow a coupling between the cover 1100 and the torsional vibration filtering device 1300, the clutch 1400 comprising a piston cap 1410, at least one friction disc 1420, and a piston 1500. FIG. 1 also illustrates a first working fluid chamber 1512, wherein a pressure plate 1510 can move axially by increasing or decreasing a pressure in the first working fluid chamber 1512.

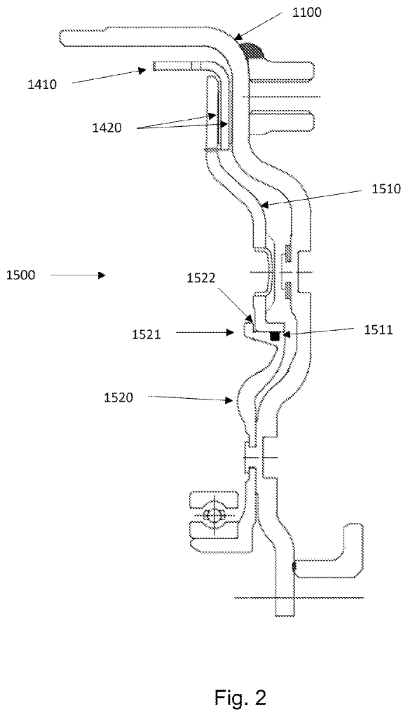

However, FIG. 2 illustrates the piston 1500, in turn, comprising the pressure plate 1510 and a cover core 1520, the pressure plate 1510 being configured to apply pressure on each friction disc 1420 to connect the cover 1100 with the torsional vibration filtering device via the piston cap 1410, the cover core 1520 is connected to the cover 1100 and comprising in turn a mechanical stop 1521 being configured to limit an axial movement of the pressure plate 1510 and being configured to have a clearance 1522 with the pressure plate 1510.

Additionally, FIG. 2 illustrates a mechanical seal 1511 that is located between the pressure plate 1510 and the cover core 1520 and is configured for preventing the passage of working fluid and pressure losses.

According to the disclosure above, it may be noted that a clutch with torque converter clearance has been designed to prevent internal interference with the components of the torsional vibration filtering device, and to enable quick and easy assessment of clutch clearance around 360° of the piston, and it will be evident to any person skilled in the art that the embodiments of a clutch with torque converter clearance as described above and illustrated in the accompanying drawings are only illustrative and non-limiting of the present invention, since numerous changes of consideration in its details are possible without departing from the scope of the invention.

Therefore, the present invention shall not be considered as restricted except as required by the prior art and by the scope of the appended claims.

1. A clutch with torque converter clearance comprising: a piston cap; at least one friction disc; and a piston; the piston in turn comprising a pressure plate and a cover core, the pressure plate being configured to apply pressure on each friction disc to connect a cover with a torsional vibration filtering device, the cover core is connected to the cover; wherein the clutch is characterized in that the cover core comprises in turn a mechanical stop being configured to limit an axial movement of the pressure plate and being configured to have a clearance with the pressure plate.

2. The clutch according to claim 1, wherein the cover core has an “L” shape in the section where the mechanical stop is located.

3. The clutch according to claim 1, wherein the torsional vibration filtering device comprises: a drive plate that is connected to the turbine, the drive plate being configured to receive the rotational movement of the turbine and/or the clutch via the piston cap; at least one spring, wherein each spring has a first end that is connected to the drive plate and a second end that is connected to a driven plate; wherein the driven plate receives the rotational movement of the drive plate through each spring, the driven plate being connected to the transmission.

4. The clutch according to claim 1, wherein at least one clutch friction disc is coupled to the pressure plate, and the piston cap is coupled to the torsional vibration filtering device; at least one friction disc contacts the piston cap when the pressure plate is axially moved because pressure is applied to it.

5. The clutch according to claim 4, wherein the at least one friction disc and the piston cap are assembled in a multi-disc structure.

6. The clutch according to claim 4, wherein the at least one friction disc is assembled with the piston cap in a simple one-to-one structure.

7. The clutch according to claim 4, wherein the pressure plate is configured to move axially by increasing or decreasing a pressure in a first chamber of working fluid.

8. The clutch according to claim 1, wherein the piston comprises a mechanical seal that is located between the pressure plate and the cover core.

9. A torque converter comprising: a cover that is configured to receive a rotational motion from an engine, the cover is assembled with a pump housing; the pump housing being configured to receive the rotational movement of the cover, the pump housing is connected to an impeller; the impeller transferring the rotational motion to a turbine; the turbine transferring the rotational motion to a torsional vibration filtering device; the torsional vibration filtering device receiving rotational motion from the turbine and being configured to transfer rotational motion to a transmission; a clutch that being configured to allow a coupling between the cover and the torsional vibration filtering device, the clutch comprising a piston cap, and at least one friction disc; and a piston which, in turn, comprises a pressure plate and a cover core, the pressure plate being configured to apply pressure on each friction disc to connect the cover with the torsional vibration filtering device, the cover core is connected to the cover; wherein the torque converter is characterized in that the cover core comprises in turn a mechanical stop being configured to limit an axial movement of the pressure plate and being configured to have a clearance with the pressure plate.

10. The torque converter according to claim 9, wherein the cover core has an “L” shape in the section where the mechanical stop is located.

11. The torque converter according to claim 9, wherein the impeller transfers the rotational movement to the turbine by means of a working fluid.

12. The torque converter according to claim 11, wherein the working fluid is oil.

13. The torque converter according to claim 9, wherein a stator is located between the impeller and the turbine.

14. The torque converter according to claim 9, wherein the torsional vibration filtering device comprises: a drive plate that is connected to a turbine, the drive plate being configured to receive the rotational movement of the turbine and/or the clutch via the piston cap; at least one spring, wherein each spring has a first end that is connected to the drive plate and a second end that is connected to a driven plate; wherein the driven plate receives the rotational movement of the drive plate through each spring, the driven plate being connected to the transmission.

15. The torque converter according to claim 9, wherein at least one clutch friction disc is coupled to the pressure plate, and the piston cap is coupled to the torsional vibration filtering device; at least one friction disc contacts the piston cap when the pressure plate is axially moved because pressure is applied to it.

16. The torque converter according to claim 15, wherein the at least one friction disc and the piston cap are assembled in a multi-disc structure.

17. The torque converter according to claim 15, wherein the at least one friction disc is assembled with the piston cap in a simple one-to-one structure.

18. The torque converter according to claim 15, wherein the pressure plate is configured to move axially by increasing or decreasing a pressure in a first chamber of working fluid.

19. The torque converter according to claim 9, wherein the piston comprises a mechanical seal that is located between the pressure plate and the cover core.
